(19) United States
(12) Patent Application Publication
(10) Pub. No.: US 2007/0251098 A1
(43) Pub. Date: Nov. 1, 2007

(54) Multi-function pizza tool

(75) Inventors: Brian W. Smith, Sterling, IL (US); Scott A. Melton, Erie, IL (US); Keith W. Dirks, Sterling, IL (US)

Correspondence Address: GREER, BURNS & CRAIN, 300 S WACKER DR, 25TH FLOOR, CHICAGO, IL, 60606, US

(73) Assignee: WAHL CLIPPER CORPORATION

(21) Appl. No.: 11/413,569

(22) Filed: Apr. 28, 2006

(51) Int. Cl. B26B 3/00

(52) U.S. Cl. 30/142

(57) ABSTRACT

A multi-function pizza tool includes a handle with a first end and a second end, a rotating cutter blade secured to the second end, and a server blade secured to the second end and being movable between an extended position and a retracted position.

### BACKGROUND OF THE INVENTION

The present invention relates generally to culinary tools, and more specifically to such tools used in the cooking and serving of pizza.

Conventional pizza cutters include a handle with a rotating cutter blade used for cutting slices from the cooked pizza. However, such cutters are unable to be used in serving the cut pizza. Supplemental trowels or spatulas are needed for such tasks. While sometimes used to separate pizza slices, spatulas are awkward to use and are not as effective in cutting slices as is a rotating blade cutter. Pizza culinary techniques further include the insertion of the pizza into, and withdrawal from the oven on conventional oven racks. Often the pizza is placed on a flat or deep dish pan when cooked. Withdrawal of the hot pan often requires oven mitts or supplemental tools. Thus, conventional pizza cooking techniques require multiple tools, each with a separate function.

There is a need for improved gastronomical utensils for cooking and/or serving pizza which address the drawbacks of conventional products.

### BRIEF SUMMARY OF THE INVENTION

The above-listed needs are addressed by the present multi-function pizza tool, including a conventional rotatable cutter blade with a server blade rotatable between an extended and a retracted position. In the retracted position, the cutter blade is free to cut slices of pizza. In the extended position, the server blade is usable to serve cut pizza slices. In the preferred embodiment, the tool is also provided with a clamp for grasping pizzas or pizza slices from the oven or for serving purposes. In another embodiment, the tool is provided with a hook formation for grasping oven racks pizza pans or the like and sliding them to and from the oven.

More specifically, a multi-function pizza tool includes a handle with a first end and a second end, a rotating cutter blade secured to the second end, and a server blade secured to the second end and being movable between an extended position and a retracted position.

In another embodiment, a multi-function pizza tool includes a handle with a first end and a second end, a rotating cutter blade secured to the second end. A server blade is secured to the second end and is movable between an extended position and a retracted position, and said handle is provided in hinged halves, and a bracket bearing said rotating cutter blade and said server blade is associated with a first half, and a clamp is associated with a second half, said halves being biased away from each other.

In still another embodiment, a multi-function pizza tool includes a handle with a first end and a second end, a rotating cutter blade secured to the second end, a server blade secured to the second end and being movable between an extended position and a retracted position, a bracket secured to the handle and supporting the cutter blade and the server blade about an axis. A clamp is movable between an open and a closed position, the clamp having a gripping end engageable in operational relationship to said rotating cutter blade.

### BRIEF DESCRIPTION OF THE SEVERAL VIEWS OF THE DRAWINGS

FIG. 1 is a top perspective elevation of the present multi-function pizza tool;

FIG. 2 is a top perspective of the tool of FIG. 1;

FIG. 3 is an overhead plan view of the present tool showing serving and cutting positions;

FIG. 4 is a side elevation of the tool of FIG. 1 shown in a pizza serving position;

FIG. 5 is a side elevation of the tool of FIG. 1 shown in a pizza clamping position;

FIG. 6 is a side elevation of the present pizza tool shown engaging an oven rack;

FIG. 7 is a top perspective view of an alternate embodiment of the present pizza tool, shown in an open clamp position; and

FIG. 8 is a side elevation of the tool of FIG. 7 shown in a closed clamp position.

### DETAILED DESCRIPTION OF THE INVENTION

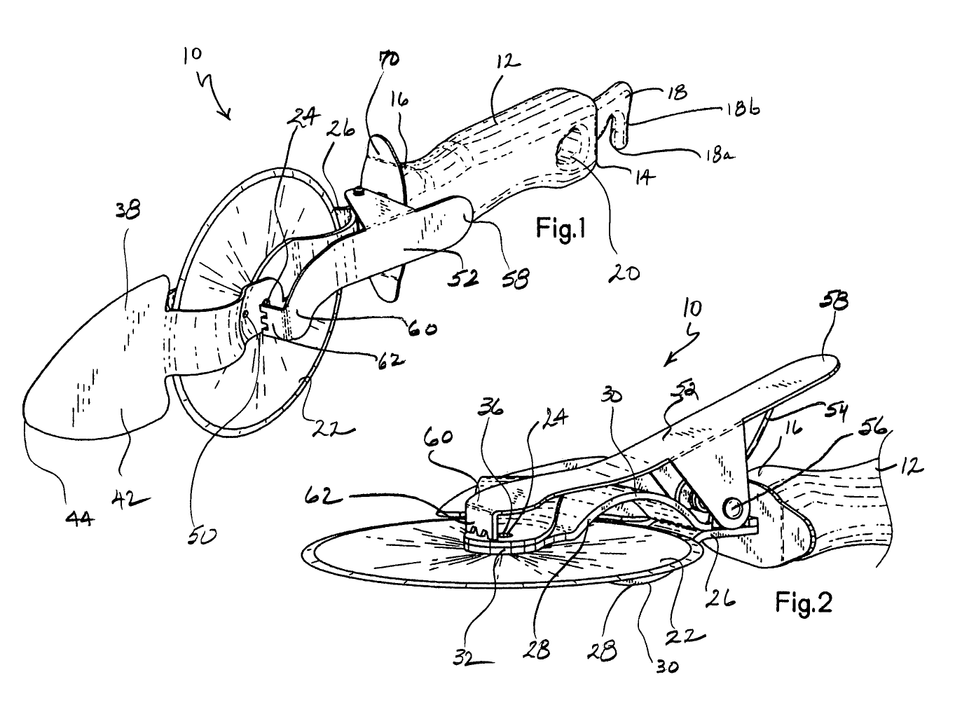

Referring now to FIGS. 1 and 2, the present multi-function pizza tool is generally designated 10 and includes a handle 12 with a first end 14 and a second end 16. At the first end 14, a hook formation 18 is preferably provided and is constructed and arranged to engage and pull and/or push oven grates to and from ovens (FIG. 6). In the preferred embodiment, while other shapes are contemplated, the hook formation 18 preferably has a pulling surface 18a and a pushing surface 18b. Also, in the preferred embodiment, a hanging opening 20 is provided near the first end 14 for suspending the tool 10 from a hook on a wall, kitchen utensil rack or the like.

A rotating cutter blade 22 is secured to the second end 16 and rotates about an axis of rotation 24 supported by a bracket 26. While other configurations are contemplated, the preferred bracket 26 extends into and is molded into the handle 12. A pair of arms 28 extends from the second end 16 of the handle 12 and forms opposing arches 30 which permit rotation of the rotating cutter blade 22. At free ends 32, the arms 28 meet at the axis of rotation 24, and are retained together by a pivot pin 36 with the rotating cutter blade 22 rotatably sandwiched therebetween. The assembly is preferably held together by a threaded fastener, a rivet or other known fastening techniques.

Referring now to FIGS. 1-3, in the preferred embodiment, a server blade 38 is secured to the handle's second end 16 by the bracket 26 and is movable about the axis of rotation 24 between an extended position (FIG. 3, solid) and a retracted position (FIG. 3, phantom). The server blade 38 includes a shank portion 40 having an eyelet (not shown) accommodating the pivot pin 36 (FIG. 2). Preferably, the shank portion 40 and the rotating cutter blade 22 are both sandwiched between the free ends 32 of the arms 28, however it is also contemplated that the server blade 38 is pivotably secured to the axis externally of the free ends 32. The shank portion 40 is preferably integrally formed with a generally arrowhead-shaped server portion 42 ending in a point 44. Outer edges 46 (FIG. 3), with the point 44 are preferably beveled to facilitate engaging pizza slices. Also, the edges 46 are optionally provided with at least one and preferably two notch-like grasping formations 48 (best seen in FIG. 6) for engaging wire rungs of an oven rack. It will also be seen that the server blade 38 is configured so that the server portion 42 is vertically displaced relative to the arched shank portion 40 for facilitating the serving function.

Referring now to FIGS. 2, 3 and 5, the server blade 38 is moved to the retracted position when it is desired to store the tool 10 or to cut pizza slices. In this position, the server blade 38 does not obstruct the cutting action of the rotating cutting blade 22. When the slices have been cut, the user moves the server blade 38 to the extended position (FIG. 3). At least one detent formation 50, such as a boss and opening arrangement, or other engaging locking formations as are known in the art, retain the server blade 38 in the extended position.

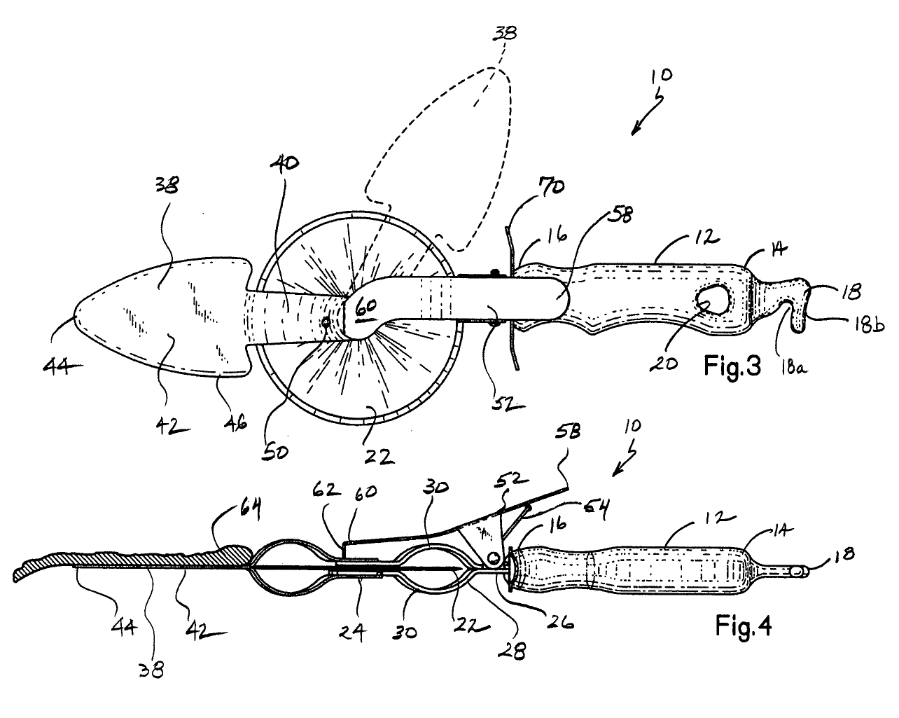

Referring now to FIGS. 1, 2, 4 and 5, another feature of the present multi-function pizza tool 10 is a clamp 52 associated with the handle 12. The clamp 52 is spring-loaded by a spring 54 (FIG. 2) or other biasing element which biases the clamp to a closed position. Preferably, the clamp 52 is secured to the bracket 26 and is movable between an open and a closed position on a clamp axis 56 transverse to the axis of rotation 24 of the cutter blade 22 and the server blade 38. A handle end 58 is used for grasping by the user to overcome the biasing force of the spring 54. Opposite the handle end 58 is a gripping end 60 provided with a plurality of teeth 62. The teeth 62 are constructed and arranged to engage the bracket 26 in the closed position. However, it is contemplated that the clamp 52 may be located on other portions of the tool 10, such as, but not restricted to, the handle 12.

In operation, the tool 10 is usable for grasping a pizza 64 using the clamp 52 and moving it into or out of the oven. Alternatively, the hook formation 18 or the grasping formations 48 are used to move an oven grate 66 as desired for inserting or withdrawing the pizza 64 from the oven. Either the pulling or pushing surfaces 18a, 18b, or the grasping surfaces 48 may be used to engaged grill bars 68 of the oven grate 66. It will also be appreciated that the handle 12 is provided with a hilt 70, preferably made of metal at the second end 16 for protecting the user's hand from high temperatures or pizza ingredients during use.

Once cooked and removed from the oven, the tool 10 is used to cut pizza slices 64, with the server blade 38 placed in the retracted position. Upon cutting the slices, the server blade 38 is moved to the extended position and held there by the detent formation 50 so that the cut slices can be served. It will be seen that the present multi-function pizza tool 10 allows the user to perform a variety of pizza-related tasks with a single tool, thus increasing cooking and serving efficiency, as well as reducing the amount of utensils to wash after use.

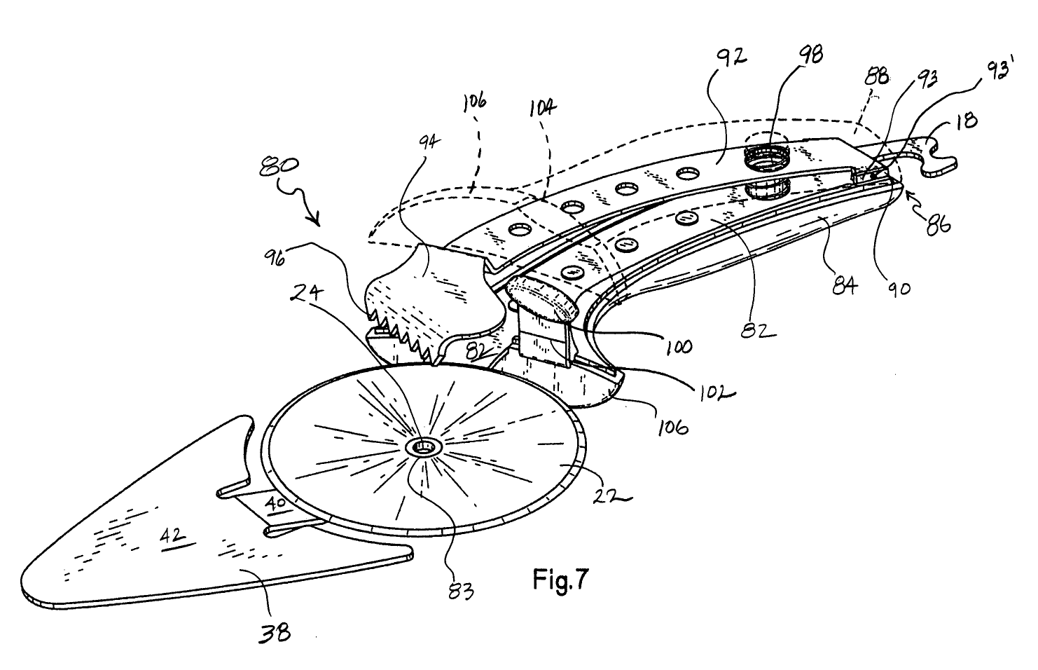

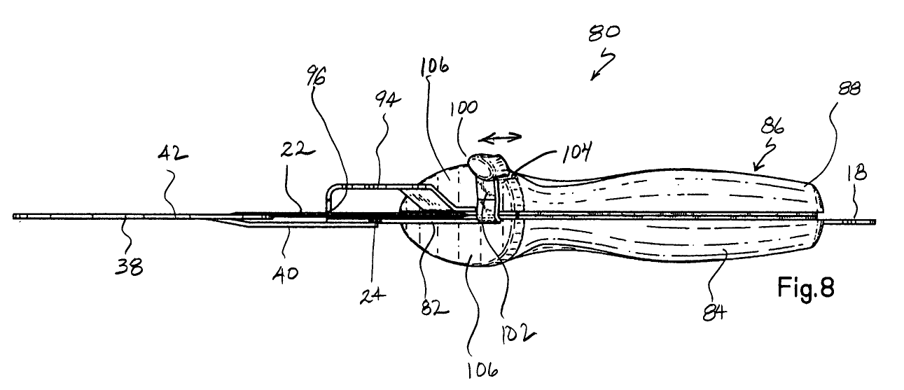

Referring now to FIGS. 7 and 8, an alternate embodiment of the present multi-function pizza tool is generally designated 80. Shared components with the tool 10 are designated with identical reference numbers. Regarding the rotating cutter blade 22 and the swiveling server blade 38, the tool 80 operates the same as the tool 10. The server blade 38 is still generally coplanar with the rotating cutter blade 22. However, the dual armed bracket 28 is replaced by a single bracket bar 82 which extends from the area of the axis of rotation 24 to the hook formation 18. The server blade 38 is also attached to the bracket 82 at the axis of rotation 24. A flared rivet 83 or similar fastener rotatably retains the blades 22, 38 in place. As is well known in the art, the bracket bar 82 is secured within a first half 84 of a handle 86 by insert molding, however other attachment techniques are contemplated.

A second handle half 88 is hingedly engaged relative to the first handle half by a hinge 90 joining an end of the bracket bar 82 near the hook formation 18 with a corresponding end of a clamp bar 92. While other configurations are contemplated, the hinge 90 includes stamped, generally perpendicularly oriented, apertured ears 93 on each of the opposing bars 82, 92 secured by a pin 93′. At its opposite end, the clamp bar 92 has a clamp 94 with at least one and preferably a plurality of downwardly extending teeth 96. Thus, as is the case with the tool 10, the clamp 94 has a clamp axis defined by the pin 93′ of the hinge 90 which is generally transverse to the axis of rotation 24.

The clamp bar 92 is secured, as by insert molding or the like, to the second handle half 88. A biasing element 98, preferably a compression spring or the like, is secured at each end to the respective handle halves 84, 88 using sockets, bosses or the like, to bias them apart to an open position (FIG. 7).

Upon grasping the handle 86, the user overcomes the biasing force of the biasing element 98 and closes the handle as seen in FIG. 8. Upon closure, the clamp 94 is configured to engage the rotating cutter blade 22 in a way that does not restrict rotation, preferably near the axis of rotation 24. To releasably retain the handle 88 in this position, a locking button 100 is attached to the first handle half 84 by a biased support 102 and projects toward the second handle half 88, however it is contemplated that the arrangement on the handle halves 84, 88 can be reversed. It is preferred that the support 102 is an integral component of the bracket bar 82, however other fabrication techniques are contemplated. A recess formation 104 on a flared hilt portion 106 of the second handle half 88 receives the button 100, which, due to the rearward bias of the support 102, maintains the handle 86 in the closed position. To release the button 100, the user merely pushes it toward the rotating cutting blade 22. Another feature of the support 102 is that it is positioned on the handle 86 to prevent the entry of food debris between the handle halves 84, 88. As is the case with the hilt 70, the hilt portion 106 protects the user from high pizza or oven temperatures, and from exposure to tomato sauce or other pizza ingredients.

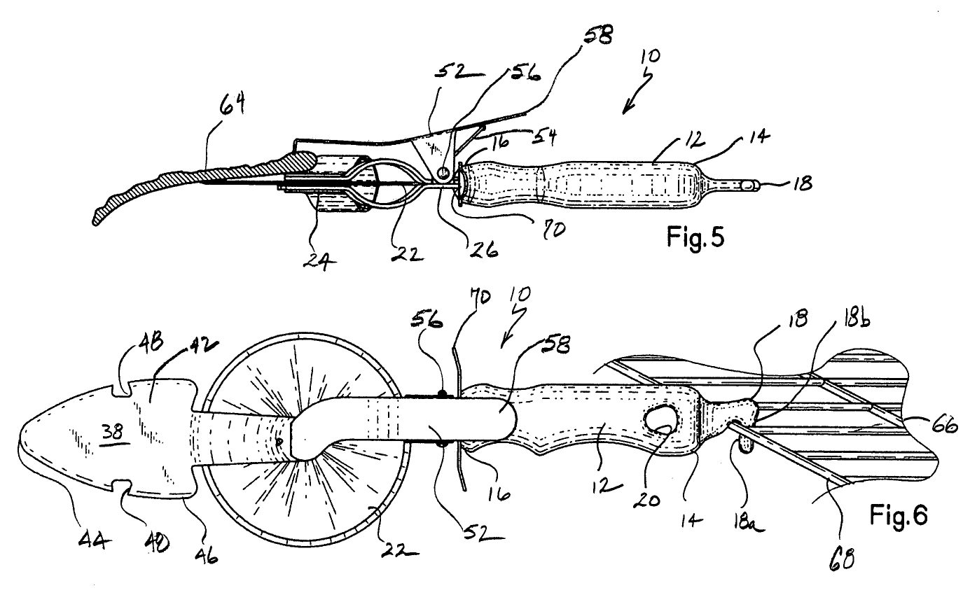

In use, as stated above, the blades 22, 38 of the tool 80 operate similarly to the tool 10. Since the clamp 94 is incorporated into the handle 84, the user must release the button -100 to grasp the pizza slice 64. The user can then determine the amount of clamping pressure to be exerted as the pizza is manipulated to or from the oven, or to or from a plate or pan. It will be understood that the clamps 52, 94 are designed for use with the blade 38 in either the extended position (FIG. 3 solid) or the retracted position (FIG. 5).

While specific embodiments of the present multi-function pizza tool have been shown and described, it will be appreciated by those skilled in the art that changes and modifications may be made thereto without departing from the invention in its broader aspects and as set forth in the following claims.

What is claimed is:

1. A multi-function pizza tool, comprising:
a handle with a first end and a second end;
a rotating cutter blade secured to said second end; and
a server blade secured to said second end and being movable between an extended position and a retracted position.

2. The tool of claim 1 wherein said cutter blade is rotatable upon an axis, said server blade also being rotatable about said axis between said extended and said retracted positions.

3. The tool of claim 2 further including at least one detent for retaining said server blade in said extended position.

4. The tool of claim 1 further including a clamp associated with said handle.

5. The tool of claim 4 wherein said clamp is biased to said closed position.

6. The tool of claim 4 wherein said clamp has a gripping end provided with a plurality of teeth.

7. The tool of claim 4 wherein said handle is provided in hinged halves, and a bracket bearing said rotating cutter blade and said server blade is associated with a first half, and said clamp is associated with a second half, said halves being biased away from each other.

8. The tool of claim 7 further including a latch for retaining said handle halves in a closed position.

9. The tool of claim 1 further including a bracket extending from said second end and rotatably supporting said cutter blade and said server blade.

10. The tool of claim 9 further including a clamp secured to said bracket and being movable between an open and a closed position on a clamp axis transverse to an axis of rotation of said cutter blade and said server blade.

11. The tool of claim 1 wherein said first end of said handle has at least one hook formation.

12. The tool of claim 1 wherein said server blade has at least one grasping formation.

13. The tool of claim 1 wherein said second end of said handle has a hilt or a hilt portion.

14. A multi-function pizza tool, comprising:
a handle with a first end and a second end;
a rotating cutter blade secured to said second end;
a server blade secured to said second end and being movable between an extended position and a retracted position; and
said handle is provided in hinged halves, and a bracket bearing said rotating cutter blade and said server blade is associated with a first half, and a clamp is associated with a second half, said halves being biased away from each other.

15. The tool of claim 14 further including a hook formation on said first end of said handle.

16. The tool of claim 15 further including a bracket secured to said handle and supporting said cutter blade, said server blade and said hook formation.

17. The tool of claim 14 further including a latch for retaining said handle halves in a closed position, said latch having a knob engageable in a recess in said second handle half.

18. The tool of claim 14 further including at least one detent for maintaining said server blade in said extended position.

19. A multi-function pizza tool, comprising:
a handle with a first end and a second end;
a rotating cutter blade secured to said second end;
a server blade secured to said second end and being movable between an extended position and a retracted position;
a bracket secured to said handle and supporting said cutter blade and said server blade about an axis;
a clamp being movable between an open and a closed position, said clamp having a gripping end engageable in operational relationship to said cutter rotating blade.
